(19) United States
(12) Patent Application Publication
(10) Pub. No.: US 2024/0354037 A1
(43) Pub. Date: Oct. 24, 2024

(54) SERVER, IMAGE FORMING APPARATUS, NON-TRANSITORY COMPUTER-READABLE MEDIUM, AND INFORMATION PROCESSING METHOD

(71) Applicant: Sharp Kabushiki Kaisha, Sakai City (JP)

(72) Inventor: KENTO WASHIDA, Sakai City (JP)

(21) Appl. No.: 18/757,583

(22) Filed: Jun. 28, 2024

(30) Foreign Application Priority Data
Mar. 7, 2023 (JP) 2023-108976

(51) Int. Cl. G06F 3/12

(52) U.S. Cl. CPC G06F 3/1269; G06F 3/1203; G06F 3/1285

(57) ABSTRACT

A server comprises one or more controllers that determine a transmission destination of data of a job to be processed by an image forming apparatus based on summary information indicating a summary of the job and operation state information indicating an operation state of the image forming apparatus.

### CROSS-REFERENCE TO RELATED APPLICATION

The present application claims priority from Japanese Application JP2023-108976, the content of which is hereby incorporated by reference into this application.

### BACKGROUND OF THE INVENTION

### 1. Field of the Invention

The present disclosure relates to a server, an image forming apparatus, a non-transitory computer-readable medium, and an information processing method.

### 2. Description of the Related Art

Conventionally, there is a known technique for saving a job to be executed by an image forming apparatus, such as a multifunctional peripheral, in another apparatus. For example, there is a known technique in which a job is saved in a server apparatus in accordance with the available capacity of a storage area of a multifunctional peripheral main body.

### SUMMARY OF THE INVENTION

However, in the related art, it is necessary for the multifunctional peripheral main body to determine whether to save the job and to transmit and receive the job to and from the server apparatus in a case where the job is saved. For this reason, for example, in a case where a plurality of jobs is intensively generated in a short period of time, the multifunctional peripheral cannot promptly execute the processing, and as a result, the processing on the multifunctional peripheral side may be delayed, or a standby time may occur on an apparatus side such as a computer that has transmitted the job to the multifunctional peripheral.

Further, in the related art, in a multifunctional peripheral, a plurality of communications may occur, such as receiving a job from an apparatus such as a computer, transmitting the job to a server to save the job, and receiving again the job saved in the server. Therefore, the amount of use of the network line increases. This problem becomes more significant when the data size of the job is large.

The present disclosure has been made in view of the above-described problems. An object of the present disclosure is to provide a server, an image forming apparatus, a non-transitory computer-readable medium, and an information processing method capable of easily preventing a decrease in performance of the image forming apparatus.

A server according to an aspect of the present disclosure includes one or more controllers that determine a transmission destination of data of a job to be processed by an image forming apparatus based on summary information indicating a summary of the job and operation state information indicating an operation state of the image forming apparatus.

An image forming apparatus according to an aspect of the present disclosure is the image forming apparatus included in an information processing system including an information processing apparatus, a server, and the image forming apparatus connected to enable information communication with each other, and the image forming apparatus transmits operation state information indicating an operation state of the image forming apparatus to the server, receives data of a job to be processed by the image forming apparatus transmitted from the information processing apparatus based on transmission destination information indicating a transmission destination of the data of the job determined by the server based on the operation state information and summary information indicating a summary of the job transmitted from the information processing apparatus to the server, and executes processing based on the received data of the job.

A non-transitory computer-readable medium according to an aspect of the present disclosure stores a program causing an information processing apparatus to execute processing including: when accepting an operation input for executing a job, generating summary information indicating a summary of the job based on the operation input; and transmitting the generated summary information to a server.

An information processing method according to an aspect of the present disclosure is an information processing method implemented by a server and includes determining a transmission destination of data of a job to be processed by an image forming apparatus based on summary information indicating a summary of the job and operation state information indicating an operation state of the image forming apparatus.

According to the present disclosure, it is possible to provide a server, an image forming apparatus, a non-transitory computer-readable medium, and an information processing method capable of easily preventing a decrease in performance of an image forming apparatus.

### BRIEF DESCRIPTION OF THE DRAWINGS

FIG. 1 is a schematic diagram illustrating an example of an information processing system according to an embodiment.

FIG. 2 is a functional block diagram illustrating an example of a schematic configuration of an information processing apparatus illustrated in FIG. 1.

FIG. 3 is a functional block diagram illustrating an example of a schematic configuration of a cloud server illustrated in FIG. 1.

FIG. 4 is a functional block diagram illustrating an example of a schematic configuration of a multifunctional peripheral illustrated in FIG. 1.

FIG. 5 is a sequence diagram illustrating an example of a processing procedure executed by the information processing system of FIG. 1.

FIG. 6 is a diagram illustrating an example of an input screen for accepting an input of a print job.

FIG. 7 is a diagram illustrating an example of an image indicating that the processing of registering a print job is being executed.

FIG. 8 is a diagram illustrating an example of an image indicating that a print job has been registered.

FIG. 9 is a flowchart illustrating an example of the processing executed by a cloud server.

FIG. 10 is a flowchart illustrating another example of the processing executed by the cloud server.

FIG. 11 is a flowchart illustrating an example of the processing executed by the cloud server when the transmission destination of a new job is the cloud server.

FIG. 12 is a flowchart illustrating an example of the processing executed by the information processing apparatus.

FIG. 13 is a flowchart illustrating an example of the processing executed by the information processing system.

### DETAILED DESCRIPTION OF THE INVENTION

Hereinafter, an embodiment of the present disclosure will be described with reference to the drawings. In the drawings, the same or equivalent components are denoted by the same reference numerals, and the description of the same or equivalent components will be omitted as appropriate in a case where the description overlaps.

### Overall Configuration

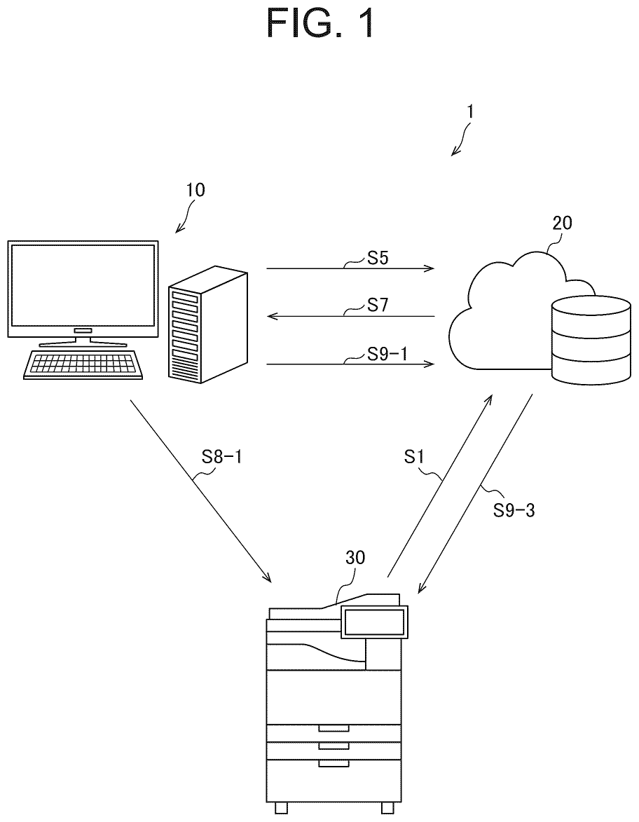

FIG. 1 is a schematic diagram illustrating an example of an information processing system 1 according to an embodiment. As illustrated in FIG. 1, the information processing system 1 includes an information processing apparatus 10, a cloud server 20, and a multifunctional peripheral 30. The information processing apparatus 10, the cloud server 20, and the multifunctional peripheral 30 are connected via a network such as the Internet to enable information communication with each other. The information processing apparatus 10 and the multifunctional peripheral 30 may be connected to enable information communication by another method such as Bluetooth (registered trademark) or a wireless local area network (LAN).

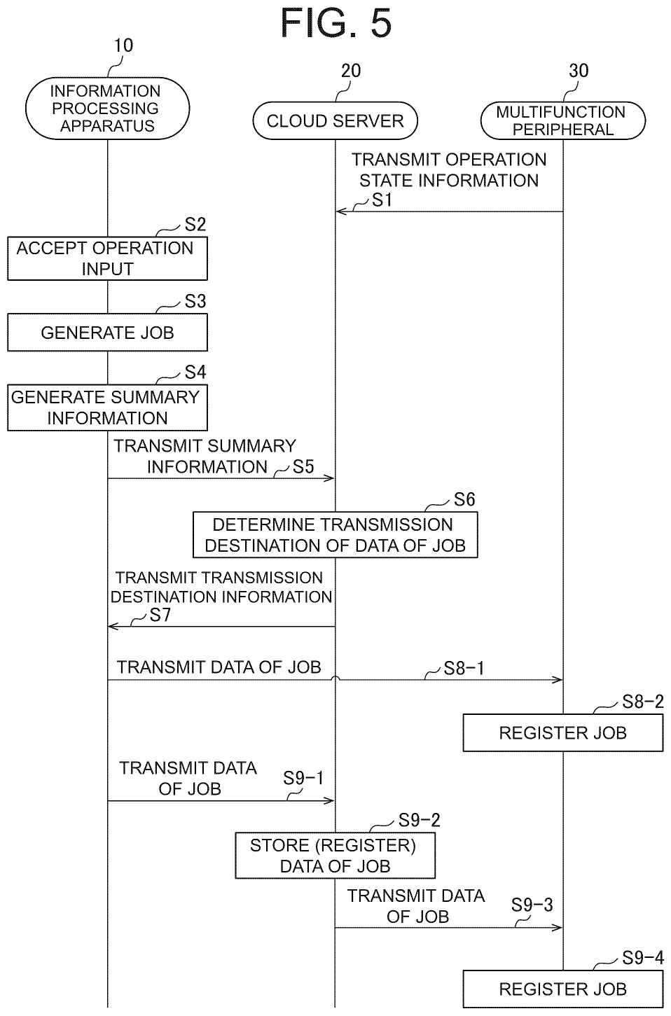

The arrows illustrated in FIG. 1 indicate a state of information communication among the information processing apparatus 10, the cloud server 20, and the multifunctional peripheral 30. The reference numerals attached to the respective arrows correspond to the reference numerals attached to the sequence diagram illustrated in FIG. 5 described below. Details of the information communication indicated by each arrow will be described in the description of FIG. 5.

The information processing apparatus 10 is an apparatus capable of generating a job indicating processing contents to be executed by the multifunctional peripheral 30. The information processing apparatus 10 is a terminal apparatus used by a user and can be configured by, for example, a smartphone or a computer.

The cloud server 20 is a virtual server device provided in the cloud. However, the information processing system 1 may not necessarily include the cloud server 20, and may include what is called a physical server instead of the cloud server 20. That is, the information processing system 1 may include at least a server. According to the present embodiment, it is assumed in the description that the server included in the information processing system 1 is the cloud server 20. The cloud server 20 determines the transmission destination of the job generated by the information processing apparatus 10 from the information processing apparatus 10. Details of a method for determining the transmission destination of the job by the cloud server 20 will be described below.

The multifunctional peripheral 30 is an example of an image forming apparatus. The image forming apparatus is an apparatus that forms and outputs an image, such as a copier or a multifunctional peripheral having a copying function such as a printer using an electrophotographic system for image formation with toner, or a multifunctional peripheral (MFP) having functions other than copying. According to the present embodiment, it is assumed in the description that the image forming apparatus is the multifunctional peripheral 30.

The multifunctional peripheral 30 can execute processing based on a job generated by the information processing apparatus 10. The multifunctional peripheral 30 can execute processing such as copying, facsimile (FAX), scanning, and printing.

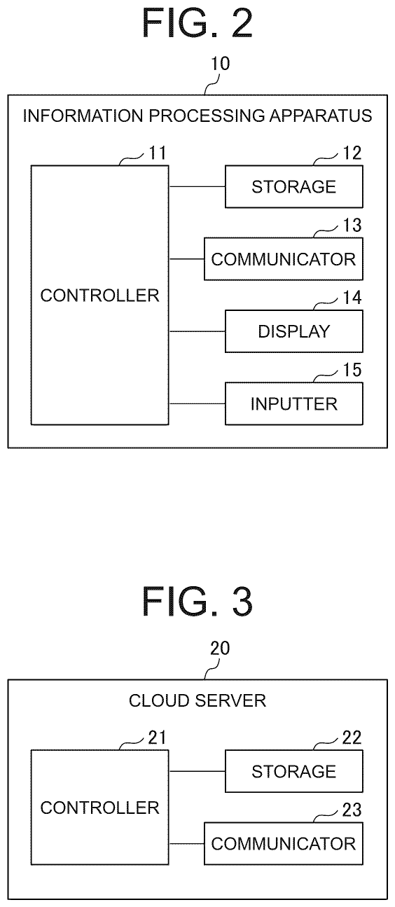

FIG. 2 is a functional block diagram illustrating an example of a schematic configuration of the information processing apparatus 10 illustrated in FIG. 1. As illustrated in FIG. 2, the information processing apparatus 10 includes, as functional units, the one or more controllers 11, a storage 12, a communicator 13, a display 14, and an inputter 15.

The one or more controllers 11 control and manage the entire information processing apparatus 10 including each functional unit of the information processing apparatus 10. The one or more controllers 11 perform various kinds of control by, for example, operating a control program stored in the storage 12. For example, the one or more controllers 11 can be configured by a control device such as a central processing unit (CPU) or a micro processing unit (MPU).

For example, when the inputter 15 accepts a predetermined operation input for executing a job from a user, the one or more controllers 11 generate a job based on the operation input. According to the present embodiment, a case where the one or more controllers 11 generate a print job based on an operation input of a user will be described.

In addition, the one or more controllers 11 generate information (hereinafter, also referred to as “summary information” in the present specification) indicating a summary of the generated job. The summary information includes information necessary for the cloud server 20 to determine a transmission destination of a job. The summary information includes, for example, the number of copies, the time limit, and the data size. The number of copies is the number of copies to be printed when the print job is executed. The number of copies is determined based on an operation input by the user. The time limit is a completion time limit of the job desired by the user. The time limit can be determined by an appropriate method based on an operation input by the user. For example, according to the present embodiment, the user selects a time limit from three categories: “no time limit”, “interruption”, and “time limit setting”. When the user selects the category “time limit setting”, the user can further designate a specific date and time as the time limit. The data size is the data size of the generated job. The example illustrated here is merely an example, and the summary information may include other information.

The storage 12 is a storage medium (non-transitory computer-readable medium) capable of storing programs and data. The storage 12 can be configured by, for example, a semiconductor memory or a magnetic memory. Specifically, the storage 12 can be configured by, for example, an electrically erasable programmable read-only memory (EEPROM). The storage 12 may store, for example, a program for operating the one or more controllers 11.

The communicator 13 performs information communication with an external device. According to the present embodiment, the communicator 13 performs information communication with the cloud server 20 and the multifunctional peripheral 30. The communicator 13 performs information communication in a wired or wireless manner, for example. The communicator 13 transmits and receives various kinds of information by information communication. For example, as will be described below in detail, the communicator 13 transmits the summary information to the cloud server 20 and transmits the data of the print job to the cloud server 20 or the multifunctional peripheral 30.

The display 14 is a device that displays an image. The display 14 includes, for example, a well-known display such as a liquid crystal display (LCD), an organic electro-luminescence display (OELD), or an inorganic electro-luminescence display (IELD). The display 14 displays various kinds of information under the control of the one or more controllers 11. For example, the display 14 displays an input screen to accept an input of a job.

The inputter 15 is a mechanism capable of accepting an operation input from a user to the information processing apparatus 10. The inputter 15 includes, for example, an operation button group provided on the main body of the information processing apparatus 10, a keyboard, and the like. In the case where the display 14 is provided with a touch sensor, the touch sensor provided in the display 14 may function as the inputter 15.

FIG. 3 is a functional block diagram illustrating an example of a schematic configuration of the cloud server 20 illustrated in FIG. 1. As illustrated in FIG. 3, the cloud server 20 includes, as functional units, one or more controllers 21, a storage 22, and a communicator 23.

The one or more controllers 21 control and manage the entire cloud server 20 including each functional unit of the cloud server 20. The one or more controllers 21 perform various kinds of control by, for example, operating a control program stored in the storage 22. For example, the one or more controllers 21 can be configured by a control device such as a CPU or an MPU.

For example, the one or more controllers 21 determine the transmission destination of the job from the information processing apparatus 10 based on the summary information acquired by the cloud server 20 from the information processing apparatus 10. At this time, the one or more controllers 21 determine the transmission destination of the job from the information processing apparatus 10, for example, based on the operation state information indicating the operation state of the multifunctional peripheral 30. Details of the operation state information will be described below.

The storage 22 is a storage medium (non-transitory computer-readable medium) capable of storing programs and data. The storage 22 can be configured by, for example, a semiconductor memory or a magnetic memory. Specifically, the storage 22 can be configured by, for example, an EEPROM. The storage 22 may store, for example, a program for operating the one or more controllers 21.

When the one or more controllers 21 determine that the transmission destination of the job is the cloud server 20, the storage 22 stores the data of the job received from the information processing apparatus 10. When storing data of a plurality of jobs, the storage 22 arranges and stores the data of the plurality of jobs in the order in which the data are processed. For example, the storage 22 stores data of a plurality of jobs by arranging the data in the order in which the data are executed by the multifunctional peripheral 30. The jobs stored in the storage 22 are transmitted from the cloud server 20 to the multifunctional peripheral 30 in the arranged order, that is, in order from the job with the earliest time limit, and are processed by the multifunctional peripheral 30. The method for arranging the jobs will be described below in detail.

The communicator 23 performs information communication with an external device. According to the present embodiment, the communicator 23 performs information communication with the information processing apparatus 10 and the multifunctional peripheral 30. The communicator 23 performs, for example, wireless information communication. The communicator 23 transmits and receives various kinds of information by information communication. For example, the communicator 23 receives summary information and job data from the information processing apparatus 10. Further, for example, the communicator 23 receives the operation state information of the multifunctional peripheral from the multifunctional peripheral 30. Further, for example, the communicator 23 transmits data of a job stored in the storage 22 to the multifunctional peripheral 30.

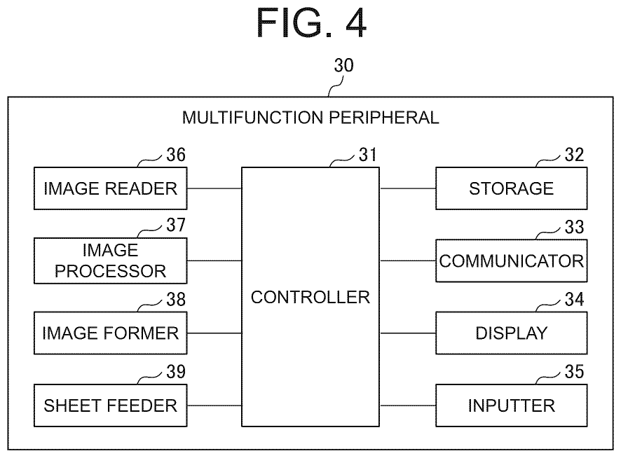

FIG. 4 is a functional block diagram illustrating an example of a schematic configuration of the multifunctional peripheral 30 illustrated in FIG. 1. As illustrated in FIG. 4, the multifunctional peripheral 30 includes, as functional units, one or more controllers 31, a storage 32, a communicator 33, a display 34, an inputter 35, an image reader 36, an image processor 37, an image former 38, and a sheet feeder 39.

The one or more controllers 31 control and manage the entire multifunctional peripheral 30 including each functional unit of the multifunctional peripheral 30. The one or more controllers 31 perform various kinds of control, for example, by operating a control program stored in the storage 32. For example, the one or more controllers 31 can be configured by a control device such as a CPU or an MPU. The one or more controllers 31 cause the job to be executed by controlling each functional unit based on the data of the received job, for example.

The storage 32 is a storage medium (non-transitory computer-readable medium) capable of storing programs and data. The storage 32 may be configured by, for example, a semiconductor memory or a magnetic memory. Specifically, the storage 32 can be configured by, for example, an EEPROM. The storage 32 may store, for example, a program for operating the one or more controllers 31.

The communicator 33 performs information communication with an external device. According to the present embodiment, the communicator 33 performs information communication with the information processing apparatus 10 and the cloud server 20. The communicator 33 performs information communication in a wired or wireless manner, for example. The communicator 33 transmits and receives various kinds of information by information communication. For example, the communicator 33 receives data of a job from the information processing apparatus 10 or the cloud server 20. Further, for example, the communicator 33 transmits the operation state information to the cloud server 20.

The operation state information is information indicating an operation state of the multifunctional peripheral 30. The operation state information includes information necessary for the cloud server 20 to determine the transmission destination of the job. The operation state information includes, for example, the available capacity of a memory, the usage rate of a CPU, and information of a job being processed. The operation state information can be generated by the one or more controllers 31 based on information acquired from each functional unit of the multifunctional peripheral 30. The information on the job being processed is information on a job whose data has been received by the multifunctional peripheral 30 and which is being executed or in a preparation stage. The information of the job being processed can be represented by, for example, the number of jobs being processed or the data size of the job being processed.

The one or more controllers 31 transmit the generated operation state information from the communicator 33 to the cloud server 20. The operation state information is periodically or non-periodically transmitted to the cloud server 20. Preferably, the operation state information is transmitted to the cloud server 20 at short intervals, and more preferably, the operation state information is constantly generated (updated) and transmitted to the cloud server 20.

The display 34 is a device that displays an image. The display 34 is configured by a well-known display such as a liquid crystal display (LCD), an organic EL display (OELD), or an inorganic EL display (IELD). The display 34 displays various kinds of information under the control of the one or more controllers 31.

The inputter 35 is a mechanism capable of accepting an operation input from a user to the multifunctional peripheral 30. The inputter 35 includes, for example, an operation button group provided on the main body of the multifunctional peripheral 30. In the case where the display 34 is provided with a touch sensor, the touch sensor provided in the display 34 may function as the inputter 35. The inputter 35 accepts, for example, an operation input for executing a predetermined job. The inputter 35 may be configured by one panel unit together with the display 34.

The image reader 36 is provided, for example, in an upper portion of the multifunctional peripheral 30. The image reader 36 is a mechanism that reads a front surface (one surface) of a document. For example, the image reader 36 includes a document table and a front surface reading unit (not illustrated). The document table is provided on an upper surface of the image reader 36, and the front surface reading unit reads a front surface of a document placed on the document table.

The image processor 37 performs image processing on image data read by the image reader 36. The image data subjected to image processing by the image processor 37 is supplied to the image former 38 and used for printing. Alternatively, the image data after the image processing by the image processor 37 may be stored in the storage 32. The image data subjected to the image processing by the image processor 37 may be transmitted to the outside via the communicator 33.

The image former 38 is provided, for example, below the image reader 36. The image former 38 prints an image based on image data read by the image reader 36 on a sheet-like image recording medium. The image recording medium is, for example, a sheet. The image former 38 can perform, for example, an electrophotographic (Carlson process) image forming processing. In this case, the image former 38 includes, for example, a photosensitive drum, a charging device, an exposure device, a developing device, a transfer device, a fusing device, a cleaning device, and a neutralization device. The image former 38 may perform printing using ink. The printed matter by the image former 38 is discharged to a sheet discharge tray (not illustrated).

The sheet feeder 39 is provided, for example, below the image former 38. The sheet feeder 39 includes one or more sheet feed cassettes. Each sheet feed cassette accommodates an image recording medium. Sheets of different sizes can be accommodated in the respective sheet feed cassettes. At the time of printing, a sheet is fed from any one of the sheet feed cassettes and supplied to the image former 38.

The configuration of the multifunctional peripheral 30 described here is merely an example, and the multifunctional peripheral 30 may have another known configuration.

### Processing Example in Information Processing System

Next, an example of processing executed by the information processing system 1 will be described. FIG. 5 is a sequence diagram illustrating an example of a processing procedure executed by the information processing system 1 of FIG. 1.

In the information processing system 1, the multifunctional peripheral 30 transmits the operation state information to the cloud server 20 (Step S1). For example, the multifunctional peripheral 30 constantly transmits the operation state information. Therefore, the multifunctional peripheral 30 may constantly execute Step S1 in the sequence diagram illustrated in FIG. 5.

Conversely, for example, when printing a document or an image, the user performs an operation input for executing a print job from the inputter 15 of the information processing apparatus 10. For example, the user inputs a file or a range to be printed, the number of copies, and a time limit.

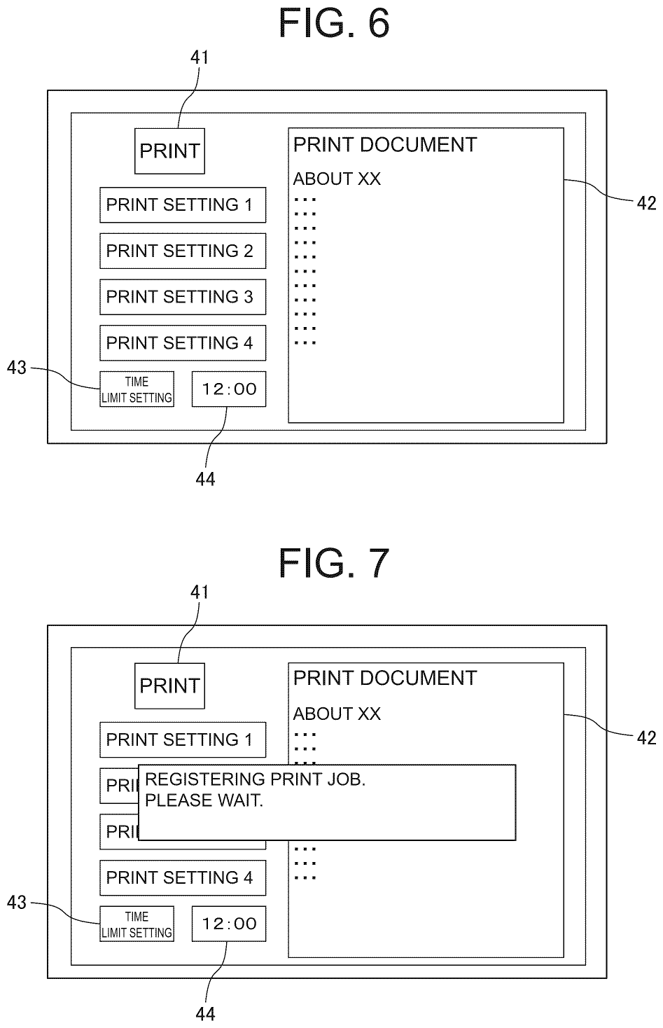

FIG. 6 is a diagram illustrating an example of an input screen for accepting an input of a print job. Based on the operation input by the user, the screen illustrated in FIG. 6 is displayed on the display 14 of the information processing apparatus 10. As illustrated in FIG. 6, for example, a preview image 42 of a file to be printed is displayed on the input screen. Further, as illustrated in FIG. 6, an input box 43 for inputting a time limit, for example, is displayed on the input screen. The user sets a time limit by selecting any one of the three categories “no time limit”, “interruption”, and “time limit setting” in the input box 43. The user can select one from a pull-down menu, for example. When the user selects the category “time limit setting”, the user inputs a specific date and time as the time limit in a date and time input box 44. In the example illustrated in FIG. 6, only the time (12:00) is input, but only the time may be input, or the date and time including the date may be input. When “no time limit” or “interruption” is selected in the input box 43, the date and time input box 44 may be grayed out or hidden. Although not illustrated in FIG. 6, the user can input the number of copies on the input screen.

A configuration may be such that the user is able to specify other settings related to printing. Specifically, the user may be able to specify settings such as color or black and white, enlargement or reduction (magnification), single-sided printing or double-sided printing, and density.

When the setting of the desired printing is completed, the user selects, for example, a print button 41 illustrated in FIG. 6. The print button 41 is a button for instructing execution of printing, and when the print button 41 is selected, a print job is generated with the setting contents input by the user.

To be specific, as illustrated in FIG. 5, the information processing apparatus 10 accepts an operation input for executing a print job (Step S2).

When the print button 41 is selected, the information processing apparatus 10 generates a print job based on the operation input accepted in Step S2 (Step S3). At this time, for example, as illustrated in FIG. 7, the information processing apparatus 10 can display, on the display 14, the image indicating that the input of the print job has been accepted or the image indicating that the processing of registering the print job is being executed.

Further, the information processing apparatus 10 generates the summary information of the print job based on the operation input accepted in Step S2 (Step S4). For example, the information processing apparatus 10 acquires information on the number of copies and the time limit of the print job based on the operation input accepted in Step S2 and calculates the data size of the data included in the print job by referring to the file and the range of the print target. Thus, the information processing apparatus 10 can generate the summary information of the print job.

The information processing apparatus 10 transmits the summary information generated in Step S4 to the cloud server 20 (Step S5).

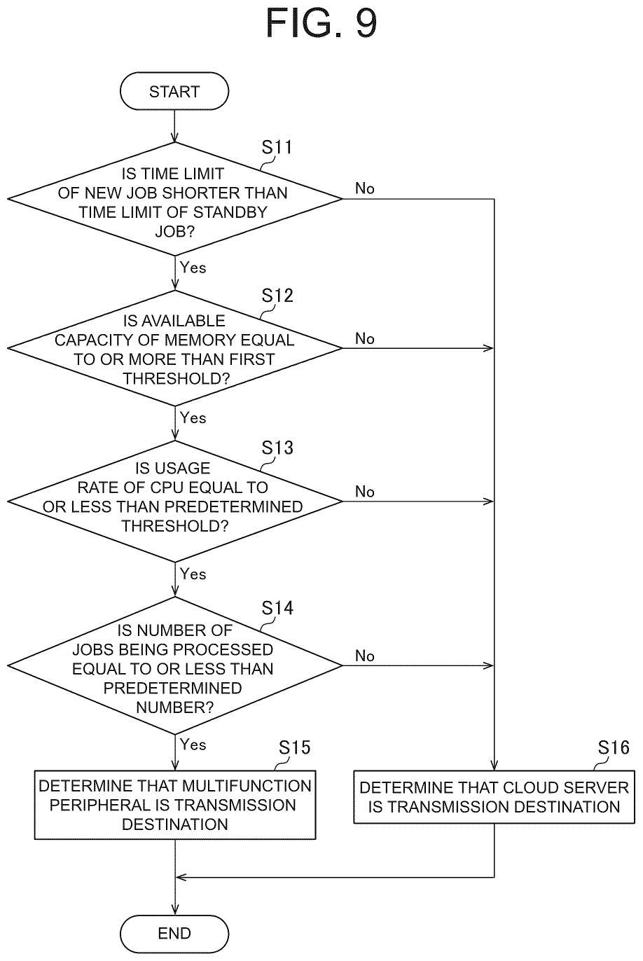

When receiving the summary information from the information processing apparatus 10, the cloud server 20 determines the transmission destination of the data of the print job generated in Step S3 based on the operation state information received from the multifunctional peripheral 30 and the summary information received from the information processing apparatus 10 (Step S6). Specifically, the cloud server 20 determines that either the cloud server 20 or the multifunctional peripheral 30 is the transmission destination of the data of the print job. At this time, since the multifunctional peripheral 30 constantly transmits the operation state information as described above, the information processing apparatus 10 determines the transmission destination of the data of the print job based on the latest operation state information when the summary information is received from the information processing apparatus 10. Details of the method for determining the transmission destination of the data of the print job will be described below with reference to FIG. 9.

When determining the transmission destination of the print job, the cloud server 20 transmits the information (hereinafter, also referred to as “transmission destination information” in the present specification) indicating the determined transmission destination to the information processing apparatus 10 (Step S7).

Based on the transmission destination information received from the cloud server 20, the information processing apparatus 10 transmits the data of the job generated in Step S3 to either the cloud server 20 or the multifunctional peripheral 30. That is, Steps S8-1 and S8-2 or Steps S9-1 to S9-4 are executed in accordance with the transmission destination.

Specifically, when the transmission destination information indicates that the transmission destination is the multifunctional peripheral 30, the information processing apparatus 10 transmits the data of the job to the multifunctional peripheral 30 (Step S8-1). As a result, the job is registered in the multifunctional peripheral 30 (Step S8-2). The registered job is executed in the multifunctional peripheral 30. That is, in this example, the printing processing is performed.

Conversely, when the transmission destination information indicates that the transmission destination is the cloud server 20, the information processing apparatus 10 transmits the data of the job to the cloud server 20 (Step S9-1). The cloud server 20 stores the received data of the job in the storage 22. As a result, the job is registered in the cloud server 20 (Step S9-2).

The cloud server 20 transmits the data of the job stored in the storage 22 to the multifunctional peripheral 30 based on, for example, the operation state information received from the multifunctional peripheral 30 (Step S9-3). That is, the cloud server 20 determines the timing of transmitting the data of the job stored in the storage 22 based on, for example, the operation state information received from the multifunctional peripheral 30 and transmits the data of the job stored in the storage 22 to the multifunctional peripheral 30 at the determined timing (Step S9-3). For example, the cloud server 20 constantly monitors the available capacity of the memory of the multifunctional peripheral 30, the usage rate of the CPU, and the job being processed. The cloud server 20 transmits the data of the job stored in the storage 22 to the multifunctional peripheral 30 when the available capacity of the memory of the multifunctional peripheral 30 becomes equal to or more than a predetermined threshold or when the usage rate of the CPU of the multifunctional peripheral 30 and the job being processed become less than a predetermined threshold. As a result, the job is registered in the multifunctional peripheral 30 (Step S9-4). The registered job is executed in the multifunctional peripheral 30.

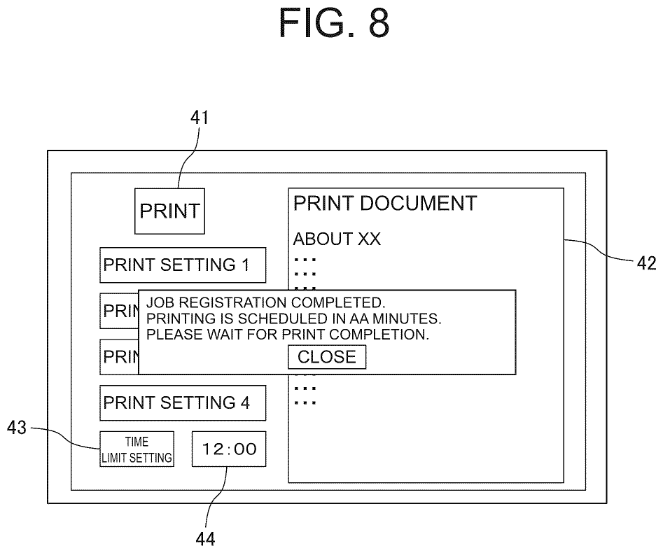

When the job is registered in the cloud server 20 or the multifunctional peripheral 30, the information processing apparatus 10 can display an image indicating that the job has been registered on the display 14, for example, as illustrated in FIG. 8. Specifically, for example, when the data of the job is transmitted based on the transmission destination information, or when the information indicating that the job has been registered is received from the transmission destination (the cloud server 20 or the multifunctional peripheral 30) of the data of the job, the information processing apparatus 10 displays the image indicating that the job has been registered. Further, as illustrated in FIG. 8, the information processing apparatus 10 may display, on the display 14, the information of the scheduled time at which the processing of the print job is completed. The scheduled time at which the processing of the print job is completed is calculated by, for example, the cloud server 20 using the method described below.

In the example illustrated in FIG. 5, it has been described that the information processing apparatus 10 generates the print job (Step S3) and generates the summary information of the print job (Step S4) when the operation input is accepted. However, the information processing apparatus 10 may generate only the summary information of the print job at this stage (Step S4). The information processing apparatus 10 may generate the print job at least before transmitting the data of the job in Step S8-1 or Step S9-1. Therefore, the information processing apparatus 10 may generate the print job after receiving the transmission destination information in Step S7, for example.

### Method for Determining Transmission Destination

Next, the method for determining the transmission destination of the job executed by the cloud server 20 will be described in detail. FIG. 9 is a flowchart illustrating an example of the processing executed by the cloud server 20 and, specifically, is a flowchart illustrating an example of processing of determining the transmission destination of the job. Therefore, the flow illustrated in FIG. 9 illustrates a specific example of the processing executed in Step S6 of FIG. 5.

According to the present embodiment, the cloud server 20 determines the transmission destination of the job based on the time limit of the job, the available capacity of the memory of the multifunctional peripheral 30, the usage rate of the CPU of the multifunctional peripheral 30, and the number of jobs being processed in the multifunctional peripheral 30.

For example, as illustrated in FIG. 9, the one or more controllers 21 of the cloud server 20 determine whether the time limit of the new job is shorter than the time limit of the standby job (Step S11). Here, the new job is a job for which the cloud server 20 determines the transmission destination. To be specific, the new job is a job generated by the information processing apparatus 10 in Step S3 of FIG. 5. The one or more controllers 21 can acquire the time limit of the new job by referring to the time limit information included in the summary information received from the information processing apparatus 10. Further, the standby job is a job in a standby state without being executed. Specifically, the job is a job that has been transmitted from the information processing apparatus 10 to the cloud server 20, has not yet been transmitted from the cloud server 20 to the multifunctional peripheral 30, and is stored in the storage 22. The one or more controllers 21 can acquire the time limit of the standby job by referring to the time limit information included in the data of the job stored in the storage 22.

In Step S11, the one or more controllers 21 compare the time limit of the new job with the time limit of the standby job. When the time limit of the new job is earlier than the time limit of the standby job, that is, when the time limit of the new job is before the time limit of the standby job, the one or more controllers 21 determine that the time limit of the new job is shorter than the time limit of the standby job (Yes in Step S11). Conversely, when the time limit of the new job is later than the time limit of the standby job, or when the time limit of the new job is the same as the time limit of the standby job, the one or more controllers 21 determine that the time limit of the new job is not shorter than the time limit of the standby job (No in Step S11).

When there is a plurality of standby jobs, for example, when data of a plurality jobs are stored in the storage 22, the one or more controllers 21 determine in Step S11 whether the time limit of the new job is shorter than the time limits of all the standby jobs. When the time limit of the new job is shorter than the time limits of all the standby jobs, the one or more controllers 21 determine that the time limit of the new job is shorter than the time limits of the standby jobs (Yes in Step S11), and otherwise, determine that the time limit of the new job is not shorter than the time limits of the standby jobs (No in Step S11).

In addition, for example, when the time limit of the new job is “interruption”, the one or more controllers 21 may determine that the time limit of the new job is shorter than the time limit of the standby job regardless of the time limit of the standby job (Yes in Step S11). For example, when the time limit of the new job is “no time limit”, the one or more controllers 21 may determine that the time limit of the new job is not shorter than the time limit of the standby job regardless of the time limit of the standby job (No in Step S11). When the time limit of the new job is “time limit setting”, the one or more controllers 21 execute the determination in Step S11 based on the specific date and time input by the user.

When it is determined that the time limit of the new job is not shorter than the time limit of the standby job (No in Step S11), the one or more controllers 21 determine that the cloud server 20 is the transmission destination (Step S16). This is because, when the time limit of the new job is not shorter than the time limit of the standby job, it is considered that there is a low necessity of causing the multifunctional peripheral 30 to preferentially execute the new job over the standby job. In this case, the one or more controllers 21 generate the transmission destination information indicating that the transmission destination is the cloud server 20 and transmit the transmission destination information to the information processing apparatus 10 (Step S7 in FIG. 5).

Conversely, when it is determined that the time limit of the new job is shorter than the time limit of the standby job (Yes in Step S11), the one or more controllers 21 then determine whether the available capacity of the memory of the multifunctional peripheral 30 is equal to or more than a first threshold (Step S12). Here, the first threshold is a threshold for the capacity at which the performance of the multifunctional peripheral 30 can be equal to or more than a certain standard. The first threshold is previously determined based on, for example, the specifications of the multifunctional peripheral 30 or the entire information processing system 1, and is stored in the storage 22. The one or more controllers 21 can determine whether the available capacity of the memory of the multifunctional peripheral 30 is equal to or more than the first threshold by using the information on the available capacity of the memory included in the operation state information acquired from the multifunctional peripheral 30 and the first threshold stored in the storage 22.

When it is determined that the available capacity of the memory of the multifunctional peripheral 30 is less than the first threshold (No in Step S12), the one or more controllers 21 determine that the cloud server 20 is the transmission destination (Step S16). This is because, in a case where the available capacity of the memory of the multifunctional peripheral 30 is less than the first threshold, if the new job is transmitted to the multifunctional peripheral 30, the available capacity of the memory of the multifunctional peripheral 30 further decreases, and the load on the multifunctional peripheral 30 increases, and as a result, the performance of the multifunctional peripheral 30 may decrease. In this case, the one or more controllers 21 generate the transmission destination information indicating that the transmission destination is the cloud server 20 and transmit the transmission destination information to the information processing apparatus 10 (Step S7 in FIG. 5).

Conversely, when it is determined that the available capacity of the memory of the multifunctional peripheral 30 is equal to or more than the first threshold (Yes in Step S12), the one or more controllers 21 then determine whether the usage rate of the CPU of the multifunctional peripheral 30 is equal to or less than a predetermined threshold (Step S13). Here, the predetermined threshold is a threshold for the usage rate of the CPU at which the performance of the multifunctional peripheral 30 can be equal to or more than a certain standard. The predetermined threshold is previously determined based on, for example, the specifications of the multifunctional peripheral 30 or the entire information processing system 1 and is stored in the storage 22. The one or more controllers 21 can determine whether the usage rate of the CPU of the multifunctional peripheral 30 is equal to or less than the predetermined threshold by using the information of the usage rate of the CPU included in the operation state information acquired from the multifunctional peripheral 30 and the predetermined threshold stored in the storage 22.

When it is determined that the usage rate of the CPU of the multifunctional peripheral 30 is higher than the predetermined threshold (No in Step S13), the one or more controllers 21 determine that the cloud server 20 is the transmission destination (Step S16). This is because, in a case where the usage rate of the CPU of the multifunctional peripheral 30 is higher than the predetermined threshold, if the new job is transmitted to the multifunctional peripheral 30, the usage rate of the CPU of the multifunctional peripheral 30 further increases, the load on the multifunctional peripheral 30 increases, and as a result, the performance of the multifunctional peripheral 30 may decrease. In this case, the one or more controllers 21 generate the transmission destination information indicating that the transmission destination is the cloud server 20 and transmit the transmission destination information to the information processing apparatus 10 (Step S7 in FIG. 5).

Conversely, when it is determined that the usage rate of the CPU of the multifunctional peripheral 30 is equal to or less than the predetermined value (Yes in Step S13), the one or more controllers 21 then determine whether the number of jobs being processed by the multifunctional peripheral 30 is equal to or less than a predetermined number (Step S14). Here, the predetermined number is a threshold for the number of jobs at which the performance of the multifunctional peripheral 30 can be equal to or more than a certain standard. The predetermined number is previously determined based on, for example, the specifications of the multifunctional peripheral 30 or the entire information processing system 1 and is stored in the storage 22. The one or more controllers 21 can determine whether the number of jobs being processed by the multifunctional peripheral 30 is equal to or less than the predetermined number by using the information of the job being processed included in the operation state information acquired from the multifunctional peripheral 30 and the predetermined number stored in the storage 22. In Step S14, the determination may be made based on another index related to the job being processed, such as the data size of the job being processed, instead of the number of jobs being processed.

When it is determined that the number of jobs being processed by the multifunctional peripheral 30 is larger than the predetermined number (No in Step S14), the one or more controllers 21 determine that the cloud server 20 is the transmission destination (Step S16). This is because, in a case where the number of jobs being processed by the multifunctional peripheral 30 is larger than the predetermined number, if the new job is transmitted to the multifunctional peripheral 30, the load on the multifunctional peripheral 30 further increases, and the performance of the multifunctional peripheral 30 may decrease. In this case, the one or more controllers 21 generate the transmission destination information indicating that the transmission destination is the cloud server 20 and transmit the transmission destination information to the information processing apparatus 10 (Step S7 in FIG. 5).

When it is determined that the number of jobs being processed by the multifunctional peripheral 30 is equal to or less than the predetermined number (Yes in Step S14), the one or more controllers 21 determine that the multifunctional peripheral 30 is the transmission destination (Step S15). That is, when the determinations are Yes in all of Steps S11 to S14, the one or more controllers 21 determine that the multifunctional peripheral 30 is the transmission destination. This is because, when the determinations are Yes in all of Steps S11 to S14, it is considered that the priority of the new job is higher than that of the standby job and the resources such as the memory and the CPU are sufficient to process the new job in the multifunctional peripheral 30. In this case, the one or more controllers 21 generate the transmission destination information indicating that the transmission destination is the multifunctional peripheral 30 and transmit the transmission destination information to the information processing apparatus 10 (Step S7 in FIG. 5).

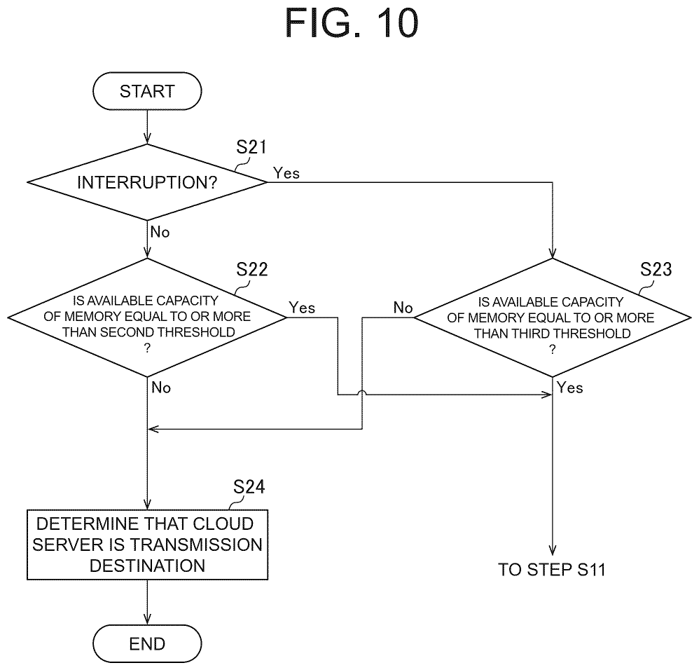

The cloud server 20 can also determine the transmission destination of the job by using a method different from the method described above with reference to FIG. 9. FIG. 10 is a flowchart illustrating another example of the processing executed by the cloud server 20. Here, another example of the method for determining the transmission destination of the job will be described with reference to FIG. 10.

In the flow illustrated in FIG. 10, the one or more controllers 21 of the cloud server 20 determine whether the time limit of the new job is “interruption” (Step S21). That is, the one or more controllers 21 determine whether the time limit of the new job is “interruption” or whether the time limit of the new job is “no time limit” or “time limit setting”.

When it is determined that the time limit of the new job is not “interruption”, that is, when it is determined that the time limit of the new job is “no time limit” or “time limit setting” (No in Step S21), the one or more controllers 21 determine whether the available capacity of the memory of the multifunctional peripheral 30 is equal to or more than a second threshold (Step S22). Here, the second threshold is a threshold for the capacity at which the performance of the multifunctional peripheral 30 can be equal to or more than a certain standard. The second threshold is, for example, a value smaller than the above-described first threshold and a value larger than a third threshold described below. The second threshold may be, for example, a threshold at which the multifunctional peripheral 30 can further process some jobs. However, the second threshold is not limited thereto, and may be the same value as the first threshold, for example. The second threshold is previously determined based on, for example, the specifications of the multifunctional peripheral 30 or the entire information processing system 1, and is stored in the storage 22. The one or more controllers 21 can determine whether the available capacity of the memory of the multifunctional peripheral 30 is equal to or more than the second threshold by using the information on the available capacity of the memory included in the operation state information acquired from the multifunctional peripheral 30 and the second threshold stored in the storage 22.

When it is determined that the available capacity of the memory of the multifunctional peripheral 30 is less than the second threshold (No in Step S22), the one or more controllers 21 determine that the cloud server 20 is the transmission destination (Step S24). This is because, in a case where the available capacity of the memory of the multifunctional peripheral 30 is less than the second threshold, if the new job is transmitted to the multifunctional peripheral 30, the available capacity of the memory of the multifunctional peripheral 30 further decreases, the load on the multifunctional peripheral 30 increases, and as a result, the performance of the multifunctional peripheral 30 may decrease. In this case, the one or more controllers 21 generate the transmission destination information indicating that the transmission destination is the cloud server 20 and transmit the transmission destination information to the information processing apparatus 10 (Step S7 in FIG. 5).

Conversely, when the one or more controllers 21 determine that the available capacity of the memory of the multifunctional peripheral 30 is equal to or more than the second threshold (Yes in Step S22), the process proceeds to Step S11 of FIG. 9. That is, in this case, the one or more controllers 21 determine the transmission destination of the job by executing the processing in and after Step S11 in FIG. 9. However, since the determination of the threshold for the available capacity of the memory has already been executed in Step S22, the one or more controllers 21 may not execute Step S12 of FIG. 9.

When it is determined in Step S21 that the time limit of the new job is “interruption” (Yes in Step S21), the one or more controllers 21 determine whether the available capacity of the memory of the multifunctional peripheral 30 is equal to or more than a third threshold (Step S23). Here, the third threshold is a threshold (limit value) indicating the minimum capacity necessary for the multifunctional peripheral 30 to normally process a job. That is, when the available capacity of the memory is less than the third threshold, there is a high possibility that the multifunctional peripheral 30 cannot normally process a job. The third threshold is smaller than the second threshold. The third threshold is previously determined based on, for example, the specifications of the multifunctional peripheral 30 or the entire information processing system 1, and is stored in the storage 22. The one or more controllers 21 can determine whether the available capacity of the memory of the multifunctional peripheral 30 is equal to or more than the third threshold by using the information on the available capacity of the memory included in the operation state information acquired from the multifunctional peripheral 30 and the third threshold stored in the storage 22.

When it is determined that the available capacity of the memory of the multifunctional peripheral 30 is less than the third threshold (No in Step S23), the one or more controllers 21 determine that the cloud server 20 is the transmission destination (Step S24). When the available capacity of the memory of the multifunctional peripheral 30 is less than the third threshold, there is a high possibility that the multifunctional peripheral 30 cannot normally process the new job, and therefore, even when the job is an “interruption” job that requires urgent processing, it is determined that the cloud server 20 is the transmission destination. In this case, the one or more controllers 21 generate the transmission destination information indicating that the transmission destination is the cloud server 20 and transmit the transmission destination information to the information processing apparatus 10 (Step S7 in FIG. 5).

Conversely, when it is determined that the available capacity of the memory of the multifunctional peripheral 30 is equal to or more than the third value (Yes in Step S23), the one or more controllers 21 proceed to Step S11 of FIG. 9. That is, in this case, the one or more controllers 21 determine the transmission destination of the job by executing the processing in and after Step S11 in FIG. 9. However, since the determination of the threshold for the available capacity of the memory has already been executed in Step S23, the one or more controllers 21 may not execute Step S12 of FIG. 9. When the available capacity of the memory of the multifunctional peripheral 30 is equal to or more than the third value, the multifunctional peripheral 30 can process the new job, and therefore under the condition that other conditions (for example, Step S13 and Step S14 in FIG. 9) are satisfied, it is determined that the transmission destination of the job is the multifunctional peripheral 30 so that the “interruption” job can be processed quickly. In this way, a job whose time limit is “interruption” can be preferentially processed.

### Job Arrangement Method

Next, a method for arranging jobs to be stored in the storage 22 will be described. When it is determined that the cloud server 20 is the transmission destination by the method described with reference to FIG. 9 or 10, the one or more controllers 21 of the cloud server 20 determine the arrangement of the new job to be stored in the storage 22 of the cloud server 20. Specifically, for example, before the new job is transmitted from the information processing apparatus 10 to the cloud server 20, one or more jobs (standby jobs) transmitted from the information processing apparatus 10 to the cloud server 20 may be arranged and stored in the storage 22 of the cloud server 20. The one or more controllers 21 determine the arrangement of the new job with respect to the already arranged standby jobs.

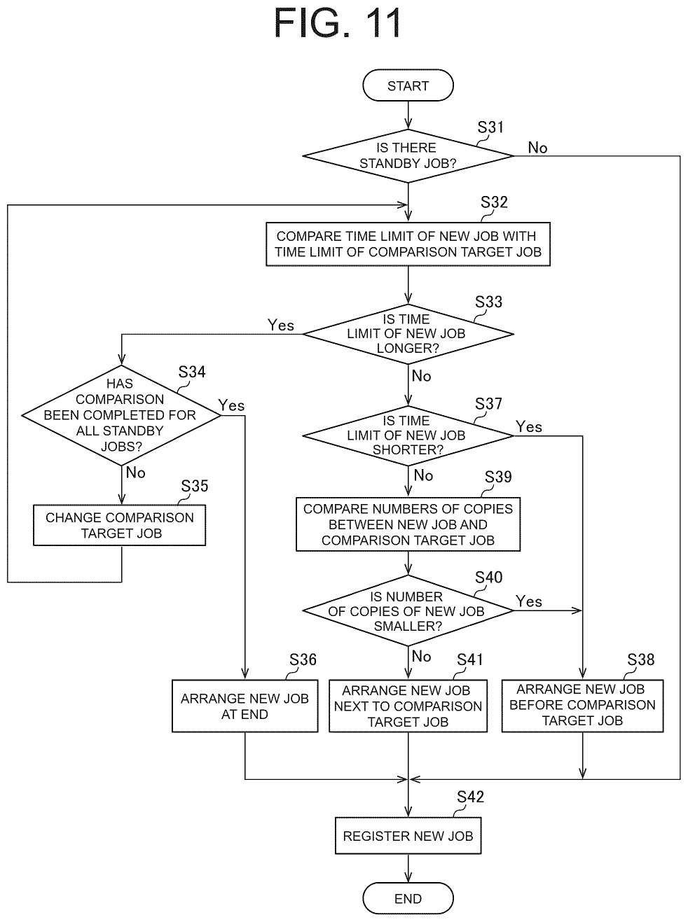

FIG. 11 is a flowchart illustrating an example of the processing executed by the cloud server 20 when the transmission destination of the new job is the cloud server 20. Specifically, FIG. 11 is a flowchart illustrating an example of a method for arranging a new job to be stored in the storage 22. The flow illustrated in FIG. 11 can be executed at appropriate timing after it is determined that the transmission destination of the new job is the cloud server 20. Therefore, for example, the flow illustrated in FIG. 11 may be executed immediately after it is determined that the transmission destination of the new job is the cloud server 20, or may be executed when the cloud server 20 receives the data of the new job from the information processing apparatus 10 (for example, Step S9-1 in FIG. 5).

The one or more controllers 21 of the cloud server 20 determine the arrangement of the new job based on at least any of the presence or absence of a standby job and the time limit and the number of copies of a job.

In the example illustrated in FIG. 11, in the arrangement of jobs, the one or more controllers 21 determine whether there is a standby job in the storage 22 (Step S31). Specifically, the one or more controllers 21 determine whether there is a job that has not yet been transmitted from the cloud server 20 to the multifunctional peripheral 30 and is stored in the storage 22.

When it is determined that there is no standby job in the storage 22 (No in Step S31), the one or more controllers 21 register the new job in the storage 22 (Step S42). Step S42 in FIG. 11 corresponds to Step S9-2 in FIG. 5.

When it is determined that there is a standby job in the storage 22, the one or more controllers 21 determine the arrangement of the new job based on the time limit and/or the processing amount, and the like, of the new job and the standby job. For example, the one or more controllers 21 determine the arrangement of the new job in accordance with the order of the time limit of each job.

In the example illustrated in FIG. 11, when it is determined that there is a standby job in the storage 22 (Yes in Step S31), the one or more controllers 21 compare the time limit of the new job with the time limit of the comparison target job (Step S32). Here, the comparison target job is one of the standby jobs. According to the present embodiment, the comparison target job is a job having the shortest (earliest) time limit among the standby jobs that have not been compared with the new job. That is, the comparison target job is a job that has not yet been compared with the new job among the arranged standby jobs and is arranged at the forefront. Therefore, when Step S32 is executed for the first time, the comparison target job is the job having the shortest time limit (i.e., arranged at the forefront) among the arranged standby jobs.

The comparison target job may not necessarily be the above-described job. The comparison target job may be one of the standby jobs, may be one job determined by a method other than the above-described method, or may be one job selected at random.

Here, the one or more controllers 21 compare the time limit of the new job with the time limit of the comparison target job having the shortest time limit among the standby jobs stored in the storage 22 (Step S32).

The one or more controllers 21 determine whether the time limit of the new job is longer than the time limit of the comparison target job (Step S33). For example, when the time limit of the new job is “interruption”, the one or more controllers 21 determine that the time limit of the new job is not longer than the time limit of the standby job regardless of the time limit of the standby job (No in Step S33). For example, when the time limit of the new job is “no time limit”, the one or more controllers 21 determine that the time limit of the new job is longer than the time limit of the standby job regardless of the time limit of the standby job (Yes in Step S33). When the time limit of the new job is “time limit setting”, the one or more controllers 21 compares the specific date and time of the time limit input for the new job with the time limit of the comparison target job and thus determine whether the time limit of the new job is longer than the time limit of the comparison target job.

When it is determined that the time limit of the new job is longer than the time limit of the comparison target job (Yes in Step S33), the one or more controllers 21 determine whether the comparison of the time limit with the new job has been completed for all the standby jobs stored in the storage 22 (Step S34).

When it is determined that the comparison of the time limit with the new job has been completed for all the standby jobs stored in the storage 22 (Yes in Step S34), the one or more controllers 21 arrange the new job at the end of the arranged standby jobs (Step S36). Then, the one or more controllers 21 register the new job in the storage 22 in the determined arrangement (Step S42). That is, in this case, since the time limit of the new job is longer than the time limits of all the standby jobs, the new job is arranged at the end of the standby jobs.

Conversely, when it is determined that the comparison of the time limit with the new job has not been completed for all the standby jobs stored in the storage 22, that is, when it is determined that there is a standby job whose time limit has not been compared with the time limit of the new job (No in Step S34), the one or more controllers 21 change the comparison target job (Step S35). Changing the comparison target job means that a job different from the job compared with the new job among the standby jobs is newly set as the comparison target job. In this example, since the comparison target job is the job having the shortest time limit among the standby jobs that have not been compared with the new job, the job having the shortest time limit among the standby jobs that have not yet been compared is set as the comparison target job after the change. For example, when the comparison with the job having the shortest time limit (that is, arranged at the forefront) among the arranged standby jobs is completed, the one or more controllers 21 determine that the standby job arranged at the second from the front is the comparison target job.

When the comparison target job is changed in Step S35, the process proceeds to Step S32, and the one or more controllers 21 compare the time limit between the new job and the changed comparison target job. The one or more controllers 21 repeat the processing from Step S32 to Step S35 until it is determined that the time limit of the new job is not longer than the time limit of the comparison target job (No in Step S33) or it is determined that the comparison of the time limit with the new job has been completed for all the standby jobs stored in the storage 22 (Yes in Step S34).

Conversely, when it is determined in Step S33 that the time limit of the new job is not longer than the time limit of the comparison target job (No in Step S33), the one or more controllers 21 determine whether the time limit of the new job is shorter than the time limit of the comparison target job (Step S37). For example, when the time limit of the new job is “interruption”, the one or more controllers 21 determine that the time limit of the new job is shorter than the time limit of the standby job regardless of the time limit of the standby job (Yes in Step S37). When the time limit of the new job is “time limit setting”, the one or more controllers 21 compares the specific date and time of the time limit input for the new job with the time limit of the comparison target job and thus determine whether the time limit of the new job is shorter than the time limit of the comparison target job.

When it is determined that the time limit of the new job is shorter than the time limit of the comparison target job (Yes in Step S37), the one or more controllers 21 arrange the new job before the comparison target job at the time of this determination (Step S38). Then, the one or more controllers 21 register the new job in the storage 22 in the determined arrangement (Step S42). As a result, the new job is arranged in accordance with the order of the time limit in the standby jobs.

Conversely, when the one or more controllers 21 determine that the time limit of the new job is not shorter than the time limit of the comparison target job (No in Step S37), it means that the time limit of the new job and the time limit of the comparison target job are the same. In this case, the one or more controllers 21 determine the arrangement of the new job based on the processing amounts of the new job and the standby job. Here, as the processing amount, the arrangement of the new job is determined based on the number of print copies of the job. To be specific, the one or more controllers 21 compare the number of copies between the new job and the comparison target job (Step S39). For example, the one or more controllers 21 compare the number of copies of the new job included in the summary information with the number of copies of the comparison target job stored in the storage 22. The one or more controllers 21 may execute Steps S39 to S41 based on other information indicating the processing amount of the job, such as the data size, instead of the number of copies.

The one or more controllers 21 determine whether the number of copies of the new job is smaller than the number of copies of the comparison target job (Step S40).

When it is determined that the number of copies of the new job is smaller than the number of copies of the comparison target job (Yes in Step S40), the one or more controllers 21 arrange the new job before the comparison target job at the time of this determination (Step S38). Then, the one or more controllers 21 register the new job in the storage 22 in the determined arrangement (Step S42). That is, according to the present embodiment, when the number of copies of the new job is smaller than the number of copies of the comparison target job, the new job is arranged in front. Thus, the new job is processed first. In this way, the new job that is expected to be completely processed earlier is processed first.

Conversely, when it is determined that the number of copies of the new job is not smaller than the number of copies of the comparison target job (No in Step S40), the one or more controllers 21 arrange the new job next to the comparison target job at the time of this determination (Step S41). Then, the one or more controllers 21 register the new job in the storage 22 in the determined arrangement (Step S42). When the number of copies of the new job is not smaller than the number of copies of the comparison target job, the number of copies of the new job is larger than the number of copies of the comparison target job, or the number of copies of the new job is the same as the number of copies of the comparison target job. If the number of copies of the new job is larger than the number of copies of the comparison target job, the comparison target job whose processing is expected to be completed earlier can be arranged before the new job for the same reason as in the case of Yes in Step S40. Further, if the number of copies of the new job is the same as the number of copies of the comparison target job, it is expected that the processing time of the new job is equal to the processing time of the comparison target job. In this case, by arranging the comparison target job before the new job, the comparison target job registered earlier than the new job can be processed first. In other words, the comparison target job registered earlier can be preferentially processed. Therefore, in any case, when it is determined that the number of copies of the new job is not smaller than the number of copies of the comparison target job (No in Step S40), the new job is arranged next to the comparison target job (Step S41).

In this way, the new job is arranged in the standby jobs and stored (registered) in the storage 22. For example, the one or more controllers 21 transmit the data of the job stored in the storage 22 to the multifunctional peripheral 30 at appropriate timing determined based on the operation state information received from the multifunctional peripheral 30. At this time, the one or more controllers 21 transmit the standby jobs to the multifunctional peripheral 30 in the arranged order. As a result, the jobs are processed by the multifunctional peripheral 30 in the arranged order.

As described above, the timing at which the standby job is transmitted from the cloud server 20 to the multifunctional peripheral 30 may be determined based on the available capacity of the memory of the multifunctional peripheral 30, the usage rate of the CPU, and the job being processed. At this time, the cloud server 20 performs the same determination processing as Steps S11 to S14 described with reference to FIG. 9, for example, and when it is determined that the transmission destination is the multifunctional peripheral 30 (Step S15), the cloud server 20 can transmit the standby jobs stored in the storage 22 to the multifunctional peripheral 30 one by one in the arranged order.

When the new job is registered in Step S42, the one or more controllers 21 may calculate a scheduled time at which the processing of the registered new job is completed. For example, the one or more controllers 21 can calculate the scheduled time at which the processing of the new job is completed based on the arrangement of the new job in the standby jobs. Specifically, the one or more controllers 21 calculate the time taken until the new job is executed based on the content of the standby job arranged before the new job and the operation state information of the multifunctional peripheral 30. Accordingly, the one or more controllers 21 can calculate the scheduled time at which the processing of the new job is completed. The one or more controllers 21 transmit the information on the calculated scheduled time to the information processing apparatus 10. For example, the one or more controllers 21 include the information of the scheduled time in the information indicating that the job has been stored (registered) in the storage 22, and transmit the information to the information processing apparatus 10. The information processing apparatus 10 can display the information of the scheduled time received from the cloud server 20 on the display 14.

### Processing Example by Information Processing Apparatus

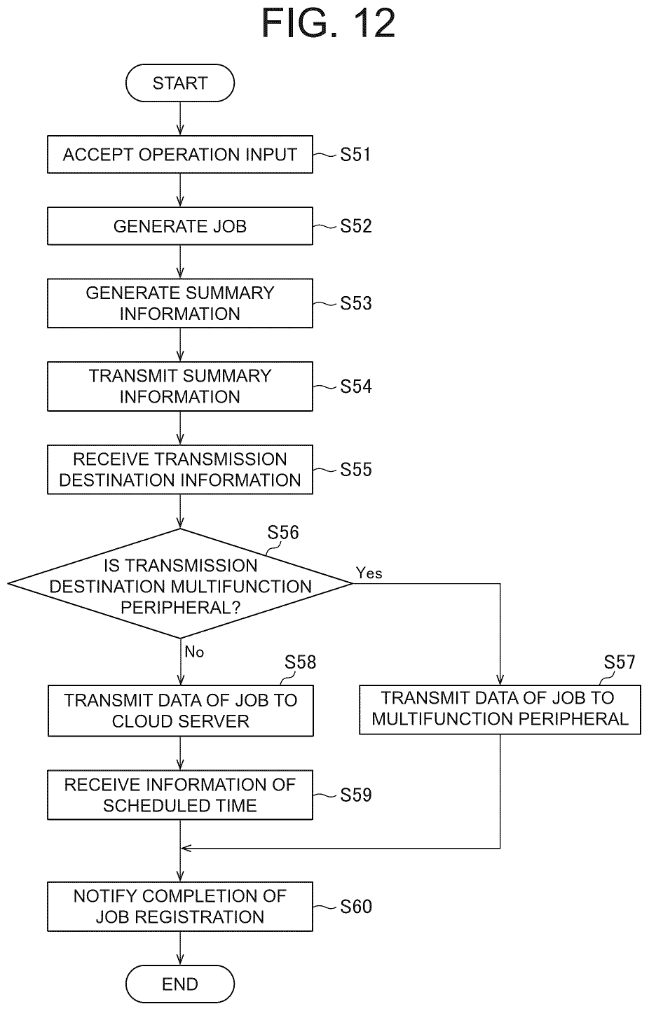

Next, processing executed by the information processing apparatus 10 will be described. FIG. 12 is a flowchart illustrating an example of the processing executed by the information processing apparatus 10.

The one or more controllers 11 of the information processing apparatus 10 accepts an operation input for executing a print job (Step S51). The one or more controllers 11 generate a print job based on the operation input accepted in Step S51 (Step S52). Further, the one or more controllers 11 generate the summary information of the generated print job (Step S53). The one or more controllers 11 transmit the summary information generated in Step S53 to the cloud server 20 (Step S54). Steps S51 to S54 correspond to Steps S2 to S5 in FIG. 5, respectively, and the description of specific processing will be omitted here.

The cloud server 20 determines the transmission destination by the above-described method based on the summary information transmitted by the information processing apparatus 10 and transmits the transmission destination information to the information processing apparatus 10.

The information processing apparatus 10 receives the transmission destination information transmitted by the cloud server 20 (Step S55). Then, the one or more controllers 11 determine whether the transmission destination is the multifunctional peripheral 30 based on the transmission destination information (Step S56).

When it is determined that the transmission destination is the multifunctional peripheral 30 (Yes in Step S56), the one or more controllers 11 transmit the data of the print job to the multifunctional peripheral 30 (Step S57). In this case, the print job is processed by the multifunctional peripheral 30. In addition, when the print job is transmitted to the multifunctional peripheral 30, the one or more controllers 11 notify the user of the completion of the job registration, for example, by displaying the completion on the display 14 (Step S60). At this time, the one or more controllers 11 can display a text such as “Please wait for print completion” on the display 14. The notification allows the user to know that the print job has been normally registered.

Conversely, when it is determined that the transmission destination is the cloud server 20, that is, when it is determined that the transmission destination is not the multifunctional peripheral 30 (No in Step S56), the one or more controllers 11 transmit the data of the print job to the cloud server 20 (Step S58).

The cloud server 20 arranges the print job (new job), for example, by the method described with reference to FIG. 11, and registers the print job in the cloud server 20. At this time, the cloud server 20 calculates the scheduled time at which the processing of the print job is completed, and transmits the information on the calculated scheduled time to the information processing apparatus 10. For example, the cloud server 20 includes the information of the scheduled time in the information indicating that the print job has been stored (registered) in the storage 22 and transmits the information to the information processing apparatus 10.

The information processing apparatus 10 receives the information of the scheduled time transmitted by the cloud server 20 (Step S59). Based on the information indicating that the print job has been stored (registered) in the storage 22, the one or more controllers 11 notify the user that the registration of the job has been completed, for example, by displaying the completion on the display 14 (Step S60). At this time, the one or more controllers 11 can display the information of the scheduled time on the display 14. This allows the user to know that the print job has been normally registered and to know the scheduled time at which the processing of the print job is completed.

### Determination of Abnormality Occurrence

In the information processing system 1, some mechanisms such as the cloud server 20 or the multifunctional peripheral 30 may become unavailable. For example, the cloud server 20 or the multifunctional peripheral 30 may not operate due to various factors including a failure or a software problem. The information processing system 1 can determine whether an abnormality has occurred in this way, and can execute information processing based on a determination result. Next, an example of the processing of determining whether an abnormality has occurred and executing the processing based on the determination result will be described.

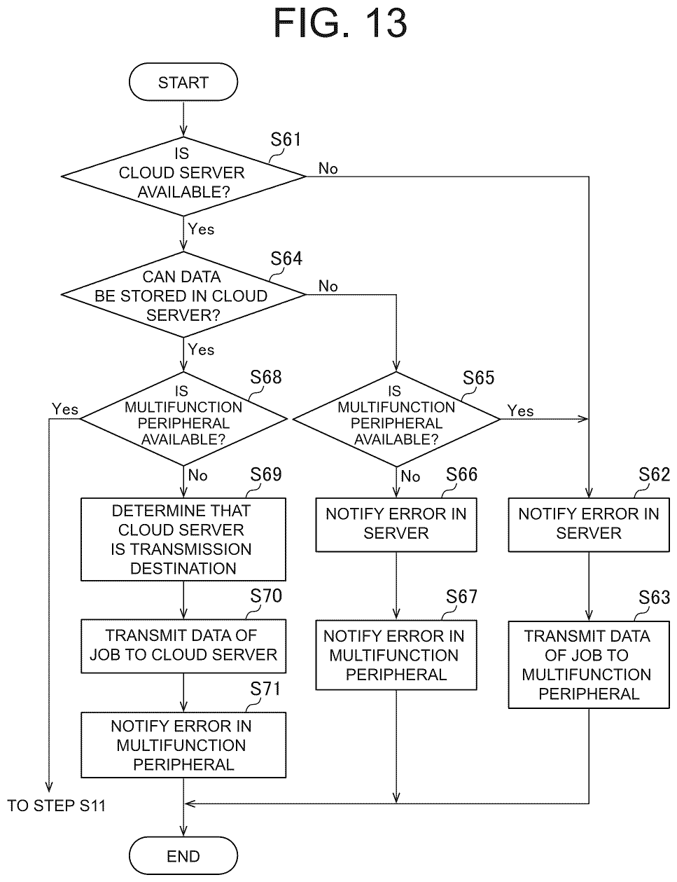

FIG. 13 is a flowchart illustrating an example of the processing executed by the information processing system 1 and, specifically, illustrating an example of the processing of determining whether an abnormality has occurred and executing the processing based on a determination result. The flow illustrated in FIG. 13 is executed, for example, when Step S5 in the sequence illustrated in FIG. 5 is executed, that is, when the information processing apparatus 10 transmits the summary information to the cloud server 20.

It should be noted that the flow illustrated in FIG. 13 is not necessarily executed by one specific mechanism included in the information processing system 1, and each step is executed by, for example, either the information processing apparatus 10 or the cloud server 20. An operation subject of each step will be described in the following description.

In the example illustrated in FIG. 13, first, the information processing apparatus 10 determines whether the cloud server 20 is available (Step S61). Here, the fact that the cloud server 20 is available means that an abnormality has not occurred in the cloud server 20 and information processing can be executed. The information processing apparatus 10 determines whether the cloud server 20 is available. For example, when the information processing apparatus 10 transmits the summary information in Step S5 of FIG. 5, the cloud server 20 transmits a response signal to the information processing apparatus 10 in response to the reception of the summary information. However, when an abnormality has occurred, the cloud server 20 cannot transmit a response signal. Therefore, after transmitting the summary information, the information processing apparatus 10 can determine whether the cloud server 20 is available based on whether a response signal has been received from the cloud server 20. For example, when the response signal has been received from the cloud server 20, the information processing apparatus 10 determines that the cloud server 20 is available (Yes in Step S61). Conversely, when no response signal has been received from the cloud server 20, the information processing apparatus 10 determines that the cloud server 20 is not available (No in Step S61).

When the information processing apparatus 10 determines that the cloud server 20 is not available (No in Step S61), the information processing apparatus 10 notifies the user that an error has occurred in the cloud server 20 (Step S62). For example, the information processing apparatus 10 can make a notification by displaying, on the display 14, that an error has occurred in the cloud server 20. Thus, the user can recognize that an abnormality has occurred in the cloud server 20.

In this case, the information processing apparatus 10 transmits the data of the job to the multifunctional peripheral 30 (Step S63). This is because, when an error has occurred in the cloud server 20, the cloud server 20 cannot determine the transmission destination of the data of the job and cannot store the data of the job. In this case, when no error has occurred in the multifunctional peripheral 30, the job is processed in the multifunctional peripheral 30. When the multifunctional peripheral 30 cannot receive the data of the job, the information processing apparatus 10 may notify the user that the multifunctional peripheral 30 cannot receive the data of the job.

Conversely, when the information processing apparatus 10 determines in Step S61 that the cloud server 20 is available (Yes in Step S61), the one or more controllers 21 of the cloud server 20 determine whether the data of the job can be stored in the storage 22 of the cloud server 20 (Step S64). Even when a response signal is transmitted from the cloud server 20 in response to the summary information, some abnormality may have occurred in the storage 22 of the cloud server 20. In this case, even if the cloud server 20 receives the data of the job, the data cannot be stored in the storage 22. Therefore, the one or more controllers 21 of the cloud server 20 determine whether the data of the job can be stored in the storage 22. The one or more controllers 21 can determine whether the data can be stored in the storage 22, for example, by accessing the storage 22.

When it is determined that the data of the job cannot be stored in the storage 22 (No in Step S64), the one or more controllers 21 of the cloud server 20 determine whether the multifunctional peripheral 30 is available (Step S65). Here, the fact that the multifunctional peripheral 30 is available means that no abnormality has occurred in the multifunctional peripheral 30 and the job can be processed. The one or more controllers 21 of the cloud server 20 can determine whether the multifunctional peripheral 30 is available based on, for example, the operation state information received from the multifunctional peripheral 30. For example, when the operation state information cannot be received from the multifunctional peripheral 30, the one or more controllers 21 can determine that the multifunctional peripheral 30 is in a state where the multifunctional peripheral 30 cannot transmit the operation state information and determine that the multifunctional peripheral 30 is not available (No in Step S65). Alternatively, when the operation state information can be received from the multifunctional peripheral 30, the one or more controllers 21 can determine whether the multifunctional peripheral 30 is available in accordance with the content of the received operation state information. For example, when the information indicating an abnormality is included in the operation state information, the one or more controllers 21 can determine that the multifunctional peripheral 30 is not available (No in Step S65), and when the information indicating an abnormality is not included in the operation state information, the one or more controllers 21 can determine that the multifunctional peripheral 30 is available (Yes in Step S65).

When it is determined that the multifunctional peripheral 30 is available (Yes in Step S65), the one or more controllers 21 transmit the information indicating that an abnormality has occurred in the cloud server 20 to the information processing apparatus 10. Based on the information received from the cloud server 20, the information processing apparatus 10 notifies the user that an error has occurred in the cloud server 20 (Step S62). For example, the information processing apparatus 10 can make a notification by displaying, on the display 14, that an error has occurred in the cloud server 20. In this case, the information processing apparatus 10 may notify that an abnormality has occurred in the storage 22 of the cloud server 20 based on the information received from the cloud server 20.

In addition, when it is determined that the multifunctional peripheral 30 is available (Yes in Step S65), the one or more controllers 21 determine that the multifunctional peripheral 30 is the transmission destination of the data of the job. This is because the data of the job cannot be stored in the storage 22 of the cloud server 20 but the multifunctional peripheral 30 is available. In this case, the one or more controllers 21 transmit, to the information processing apparatus 10, the transmission destination information indicating that the transmission destination of the data of the job is the multifunctional peripheral 30. The information processing apparatus 10 transmits the data of the job to the multifunctional peripheral 30 based on the transmission destination information (Step S63). As a result, the job is registered in the multifunctional peripheral 30. When the multifunctional peripheral 30 cannot receive the data of the job, the information processing apparatus 10 may notify the user that the multifunctional peripheral 30 cannot receive the data of the job.

Conversely, in Step S65, when it is determined that the multifunctional peripheral 30 is not available (No in Step S65), the one or more controllers 21 transmit the information indicating that an abnormality has occurred in the cloud server 20 and the multifunctional peripheral 30 to the information processing apparatus 10. Based on the information received from the cloud server 20, the information processing apparatus 10 notifies the user that an error has occurred in the cloud server 20 (Step S66). Based on the information received from the cloud server 20, the information processing apparatus 10 notifies the user that an error has occurred in the multifunctional peripheral 30 (Step S67). For example, the information processing apparatus 10 can perform notification by display on the display 14. In this case, the data of the job is transmitted to neither the cloud server 20 nor the multifunctional peripheral 30. Therefore, the information processing apparatus 10 may further notify that the job cannot be registered.

When it is determined in Step S64 that the data of the job can be stored in the storage 22 (Yes in Step S64), the one or more controllers 21 of the cloud server 20 determine whether the multifunctional peripheral 30 is available (Step S68). Since the determination method in Step S68 is the same as that in Step S65, the detailed description thereof will be omitted here.

When the one or more controllers 21 of the cloud server 20 determine that the multifunctional peripheral 30 is available (Yes in Step S68), the process proceeds to Step S11 of FIG. 9. That is, in this case, since it is considered that both the cloud server 20 and the multifunctional peripheral 30 are operating normally, the one or more controllers 21 determine the transmission destination of the job by executing the processing of Step S11 and the subsequent steps in FIG. 9.

Conversely, when it is determined that the multifunctional peripheral 30 is not available (No in Step S68), the one or more controllers 21 of the cloud server 20 determine that the cloud server 20 is the transmission destination (Step S69). This is because, in this case, the cloud server 20 is operating normally, but the multifunctional peripheral 30 is not operating, and therefore, the data of the job is temporarily registered in the cloud server 20. In this case, the one or more controllers 21 transmit the transmission destination information indicating that the transmission destination of the data of the job is the cloud server 20 to the information processing apparatus 10. The information processing apparatus 10 transmits the data of the job to the cloud server 20 based on the transmission destination information (Step S70). The one or more controllers 21 of the cloud server 20 store the received data of the job in the storage 22. As a result, the job is registered in the cloud server 20.

In addition, in this case, the one or more controllers 21 of the cloud server 20 transmit the information indicating that an abnormality has occurred in the multifunctional peripheral 30 to the information processing apparatus 10. Based on the information received from the cloud server 20, the information processing apparatus 10 notifies the user that an error has occurred in the multifunctional peripheral 30 (Step S71).

In this way, the information processing system 1 can execute processing in accordance with the situation, such as causing data of a job to be transmitted to an appropriate mechanism, depending on whether an abnormality has occurred.

### SUMMARY

As described above, according to the present embodiment, the one or more controllers 21 of the cloud server 20 determine the transmission destination of the data of the job based on the summary information indicating the summary of the job to be processed by the multifunctional peripheral 30, which is an image forming apparatus, and the operation state information indicating the operation state of the multifunctional peripheral 30. That is, the cloud server 20, not the multifunctional peripheral 30, determines the transmission destination of the data of the job. Therefore, it is possible to determine the transmission destination of the data of the job while efficiently securing the storage area of the multifunctional peripheral 30 without depending on the specification, the performance, or the like of the multifunctional peripheral 30. Accordingly, for example, even when jobs are intensively generated, the cloud server 20 can determine the transmission destination of the data of the job, and thus the processing of determining the transmission destination of the data of the job does not occur on the side of the multifunctional peripheral 30. As a result, it is possible to easily prevent a reduction in the performance of the multifunctional peripheral 30, which is an image forming apparatus. In addition, the information processing apparatus 10 side can more quickly transmit the data of the job to the cloud server 20 or the multifunctional peripheral 30 based on the transmission destination information from the cloud server 20 without waiting until the multifunctional peripheral 30 determines the transmission destination of the data of the job.

Further, according to the present embodiment, since the transmission destination is previously determined before the data of the job is transmitted, the communication can be efficiently performed. Specifically, the cloud server 20 handles jobs, for example, the cloud server 20 determines the transmission destination based on the operation state information of the multifunctional peripheral 30 and transmit the standby job registered in the cloud server 20 to the multifunctional peripheral 30 at appropriate timing. Therefore, it is possible to avoid the occurrence of a communication waiting state or the occurrence of communication for job return.

Further, according to the present embodiment, the cloud server 20 handles jobs and therefore, for example, in a case where a non-urgent large-volume printing job is generated, the multifunctional peripheral 30 can process the large-volume printing job when there is a margin, for example, when the multifunctional peripheral 30 is not processing another job. Therefore, it is possible to prevent a specific user from occupying the multifunctional peripheral 30.

### Modification

In the above-described embodiment, it has been described that the cloud server 20 determines the transmission destination of the job based on the time limit of the job, the available capacity of the memory of the multifunctional peripheral 30, the usage rate of the CPU of the multifunctional peripheral 30, and the number of jobs being processed in the multifunctional peripheral 30. However, the cloud server 20 may not necessarily determine the transmission destination of the job using all of them, and may determine the transmission destination of the job using only a part of them, for example. Further, the cloud server 20 may determine the transmission destination of the job by using criteria other than these.

In the above-described embodiment, the case where the job is a print job has been described; however, the job may not necessarily be a print job, and may be any job that can be processed by the multifunctional peripheral 30 based on a signal from the information processing apparatus 10. In addition, the summary information may include information necessary for determining the transmission destination of the job according to the type of the job. Regardless of the type of the job, the summary information may include, for example, at least information on the time limit.

The information processing system 1 described in the above embodiment may further have other functions. For example, the one or more controllers 21 of the cloud server 20 may determine whether the number of copies of the print job is an unnatural value such as an abnormally large number of copies based on the summary information received from the information processing apparatus 10. For example, when the number of copies of the print job exceeds a predetermined threshold of the number of copies, the one or more controllers 21 can determine that the number of copies is an unnatural value. When it is determined that the number of copies of the print job is an unnatural value, the one or more controllers 21 may cause the information processing apparatus 10 to output a warning.

Further, for example, the one or more controllers 21 of the cloud server 20 may calculate the number of sheets to be printed in the print job based on the summary information received from the information processing apparatus 10. When the calculated number of sheets exceeds a predetermined limit number of sheets, the one or more controllers 21 may cause the information processing apparatus 10 to output a warning indicating that the number of sheets exceeds the limit number of sheets and may cause the information processing apparatus 10 to stop the transmission of the print job.

Further, for example, the one or more controllers 21 of the cloud server 20 may stop the transmission of the print job based on the attendance information of the user. For example, the one or more controllers 21 acquire information in which the attendance of the user is recorded from an external device. When it is determined that the job is input at a time outside the working hours of the user based on the acquired attendance information, the one or more controllers 21 may cause the information processing apparatus 10 to stop the transmission of the print job on the assumption that the use is outside the working hours.

In addition, for example, when a plurality of groups shares the one multifunctional peripheral 30, the one or more controllers 21 of the cloud server 20 may execute the process based on information of the group to which the user who has input the print job belongs. For example, the user and the group to which the user belongs are previously stored in the storage 22 of the cloud server 20 in association with each other. When the summary information is received, the one or more controllers 21 refers to the storage 22 to specify the group to which the user belongs from the information of the user included in the summary information. When it is determined that a specific group intensively inputs jobs to the multifunctional peripheral 30 based on a criterion previously stored in the storage 22, the one or more controllers 21 may cause the multifunctional peripheral 30 to preferentially process a job of a user of a group other than the specific group. This makes it easy to avoid occupation of the multifunctional peripheral 30 by a specific group.

Further, for example, in a case where a job is processed using what is called the job hold function in which the job is stored in a hold queue once and then the job is executed, when the data of the job is transmitted to the multifunctional peripheral 30, a large storage area of the multifunctional peripheral 30 may be used. In such a case, for example, by registering a part of the data of the job in the cloud server 20, it is possible to suppress a reduction in the performance of the multifunctional peripheral 30.

Although the present disclosure has been described based on the drawings and the embodiment, it should be noted that a person skilled in the art can easily make various modifications and changes based on the present disclosure. Therefore, it should be noted that these modifications and changes fall within the range of the present disclosure. For example, the functions and the like included in each functional unit, each step, and the like can be rearranged without logical contradiction, and a plurality of functional units, steps, and the like, can be combined into one or divided.

A program that operates in each apparatus according to the embodiment is a program (program that causes a computer to function) that controls the CPU or the like so as to perform the functions according to the above-described embodiments. Information handled by these devices is temporarily accumulated in a temporary storage device (for example, a random access memory (RAM)) at the time of processing, and is then stored in a storage device such as a read only memory (ROM) or a hard disk drive (HDD), and is read, modified, or written by the CPU as necessary.

Here, the recording medium for storing the program may be any of a semiconductor medium (for example, a ROM, a nonvolatile memory card, or the like), an optical recording medium/magneto-optical recording medium (for example, a Digital Versatile Disc (DVD), a Magneto Optical Disc (MO), a Mini Disc (MD), a Compact Disc (CD), a Blu-ray (registered trademark) disc (BD, or the like), a magnetic recording medium (for example, a magnetic tape, a flexible disk, or the like), etc. Further, not only the functions according to the above-described embodiment are performed by executing the loaded program, but also the functions according to the present disclosure may be performed by performing processing in cooperation with an operating system, another application program, or the like, based on instructions of the program.

In addition, in a case where the program is distributed in the market, the program can be stored in a portable recording medium and distributed, or can be transferred to a server computer connected via a network such as the Internet. In this case, of course, the storage device of the server computer is also included in the present disclosure.

In addition, each functional block or various features of the devices used in the above-described embodiment can be implemented or executed by an electric circuit, for example, an integrated circuit or a plurality of integrated circuits. The electric circuit designed to implement the functions described herein may include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor or a conventional processor, controller, microcontroller, or state machine. The above-described electric circuit may be configured by a digital circuit or an analog circuit. In addition, in a case where an integrated circuit technology that replaces the current integrated circuit appears due to the progress of the semiconductor technology, one or more aspects of the present disclosure can use a new integrated circuit according to the technology.

While there have been described what are at present considered to be certain embodiments of the invention, it will be understood that various modifications may be made thereto, and it is intended that the appended claim cover all such modifications as fall within the true spirit and scope of the invention.

What is claimed is:

1. A server comprising one or more controllers that determine a transmission destination of data of a job to be processed by an image forming apparatus based on summary information indicating a summary of the job and operation state information indicating an operation state of the image forming apparatus.

2. The server according to claim 1, wherein the summary information includes at least information about a time limit of the job.

3. The server according to claim 1, wherein the operation state information includes at least an available capacity of a memory, a usage rate of a central processing unit (CPU), and information of a job being processed in the image forming apparatus.

4. The server according to claim 1, further comprising a storage that stores data of the job, wherein when it is determined that the transmission destination is the server, the one or more controllers determine, based on at least any of presence or absence of a standby job in a state of being stored in the storage and a time limit and a number of copies of the job, arrangement of the job in the standby job.

5. The server according to claim 4, wherein the one or more controllers determine the arrangement of the job in the standby job in accordance with an order of the time limit based on the time limits of the standby job and the job.

6. The server according to claim 4, wherein the one or more controllers transmit data of the standby job stored in the storage to the image forming apparatus based on the operation state information.

7. The server according to claim 4, wherein the one or more controllers calculate a scheduled time at which processing of the job is completed based on the arrangement of the job in the standby job.

8. An image forming apparatus included in an information processing system including an information processing apparatus, a server, and the image forming apparatus connected to enable information communication with each other, the image forming apparatus
transmits operation state information indicating an operation state of the image forming apparatus to the server,
receives data of a job to be processed by the image forming apparatus transmitted from the information processing apparatus based on transmission destination information indicating a transmission destination of the data of the job determined by the server based on the operation state information and summary information indicating a summary of the job transmitted from the information processing apparatus to the server, and
executes processing based on the received data of the job.

9. A non-transitory computer-readable medium storing a program causing an information processing apparatus to execute processing comprising:
when accepting an operation input for executing a job, generating summary information indicating a summary of the job based on the operation input; and
transmitting the generated summary information to a server.

10. The non-transitory computer-readable medium according to claim 9, storing the program causing the information processing apparatus to execute processing further comprising, when receiving transmission destination information indicating a transmission destination of data of the job from the server, transmitting the data of the job based on the transmission destination information.

11. An information processing method implemented by a server, comprising determining a transmission destination of data of a job to be processed by an image forming apparatus based on summary information indicating a summary of the job and operation state information indicating an operation state of the image forming apparatus.
